(19) United States
(12) Patent Application Publication
(10) Pub. No.: US 2009/0063334 A1
(43) Pub. Date: Mar. 5, 2009

(54) Business-to-business transaction processing utilizing electronic payment network

(76) Inventor: Alistair Duncan, Danville, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/897,142

(22) Filed: Aug. 28, 2007

(51) Int. Cl. G06Q 40/00

(52) U.S. Cl. 705/39

(57) ABSTRACT

Embodiments in accordance with the present invention relate to methods and systems allowing an electronic payment processing network to be utilized to conduct transactions between businesses (B2B) or other entities. In one embodiment, funds may be transferred between businesses (buyer, seller) through a payment processing network utilizing offsetting credit and debit transactions to an account with a dummy acquirer entity. This payment may be achieved utilizing only conventional message types (request for authorization, settlement) that are expected to be transmitted over the network during the course of a familiar merchant/consumer purchase transaction.

### BACKGROUND

Credit card transactions are generally well accepted. Computer systems have been developed to process these transactions in a reliable and secure manner. One such computer system known as VisaNet® is developed by Visa to process credit card transactions.

A familiar type of credit card transaction is shown in FIG. 1. This transaction 100 involves a number of parties, including a consumer 102 who possesses a credit card, a merchant 104 who accepts a credit card for payment, a first financial institution 106 affiliated with the consumer, a second financial institution 108 affiliated with the merchant, and a payment processing network 110 such as VisaNet®.

The first financial institution 106 affiliated with the consumer is known as the issuer. The issuer 106 issues credit cards and credit card statements to the consumer, and in turn receives payment from the consumer for credit card balances. The issuer holds and transfers monies on behalf of the consumer, to the financial institution operating on behalf of the merchant.

In particular, the second financial institution 108 affiliated with the merchant is known as the acquirer. The acquirer 108 is configured to acquire and process all of the credit card transactions involving the merchant. Specifically, the acquirer receives on behalf of the merchant, electronic payments on behalf of the consumer for credit card purchases.

An association such as Visa maintains an electronic communications network that facilitates the processing of credit card transactions. In particular, this payment processing network allows funds to be transferred from the issuer on behalf of the consumers, to the acquirer behalf of the merchants.

An example of a familiar type of credit card transaction involves the following steps. First, consumer 102 indicates to merchant 104 the items or services that are to be purchased. Merchant 104 then calculates the amount of the transaction or purchase and seeks payment from the consumer 102. The consumer 102 then proffers his/her credit card to the merchant.

The merchant 104 then runs the credit card (typically a magnetic stripe card) through a point of sale (POS) terminal. The point of sale terminal captures credit card information, unites it with sales information, and sends the information together with an authorization request in an authorization request message 112 to the acquirer 108.

Because the transaction is initiated by the merchant, the authorization request message 112 includes certain information. For example, the authorization request message 112 typically includes an amount of the purchase, a date of the purchase, and a unique credit card account number.

The authorization request message 112 also typically includes a code identifying the merchant originating the transaction. However, this code is independently issued by each acquirer, and does not uniquely identify each merchant across different financial institutions.

The acquirer 108 receives the authorization request message, and in turn forwards it through the electronic payment network to the issuer 106 that has issued the card to the consumer. The issuer processes the relevant information and the authorization request to determine whether the transaction should be authorized. For example, the issuer may determine whether or not there exists sufficient available credit in the consumer's account to cover the transaction. Other criteria for allowing or denying a purchase transaction may include an analysis for potentially fraudulent activity. Based upon this processing, the issuer 106 then sends either an approval or denial message 114 back to the acquirer 108 through the payment processing network 110.

The acquirer 108 in turn relays the approval or denial message back to the point of sale terminal of the merchant. If the transaction is authorized, the consumer is allowed to consummate the transaction with the merchant. The merchant 104 transmits a settlement message (not shown) over the payment processing network 110, and the funds are earmarked for transfer from the issuer arm of a financial institution of the consumer, to the acquirer arm of a financial institution of the merchant. If the transaction is denied, the purchase must take place utilizing another payment medium, such as cash or another type of payment card.

Typically, at a later time, the accounts maintained by the issuer and the acquirer are settled and reconciled. The credit card association deducts funds from the issuer 106 and credits funds to the acquirer 108, who receives them on behalf of the merchant 104 and transfers them to the merchant's account. Along the way, miscellaneous fees may be deducted/imposed, for example the acquirer may deduct a fee from the amount received from the issuer. A separate fee may also be charged by the credit card association for use of its payment network to facilitate the transaction.

Several points are worthy of note in connection with the familiar consumer/merchant credit card transaction just described. First, the electronic payment network is also configured to process a transaction wherein the issuer is credited with funds. For example, where goods or services are found to be faulty or unsatisfactory the consumer's account with the issuer can be credited with an amount of funds previously used for payment. In such a transaction, funds are debited from the merchant's account with the acquirer and credited back to the consumer's account with the issuer.

Also worthy of note is that the roles of the two parties are fixed with regard to other credit card transactions. Thus, the merchant is supplying goods or services to the consumer, in return for monetary compensation. In future transactions, the merchant will sell additional goods or services to other consumers, and the consumer will make additional purchases from other merchants. Thus, there is no need for the merchant to be affiliated with an issuer (in order to transfer funds out), or for the consumer to be affiliated with an acquirer (in order to receive funds in). However, in other types of credit card transactions (for example business-to-business, B2B), the roles of parties are not necessarily fixed. This is discussed in detail below.

A final thing to note is that the familiar credit card transaction is initiated by the merchant. Specifically, because the authorization request message is transmitted to the payment processing network through the acquirer, the acquirer is automatically apprised of the existence of the transaction, and specifics such as the amount, date, and the consumer's credit card account. As also noted in detail below, this is not necessarily the case with other possible types of credit card transactions.

Apart from the familiar merchant/consumer credit card transaction just illustrated, other types of transactions can benefit from the use of an electronic payment processing network. An example of such another transaction type is a business-to-business (B2B) transaction.

In such a B2B transaction, a first business sells a good or service to a second business. Such a transaction between a buyer and a seller is typically completed in the following manner.

First, a buyer issues a purchase order to a seller for goods and/or services which the buyer wishes to purchase. Upon receipt of the purchase order, the seller ships the goods to the buyer. The seller generally simultaneously forwards an invoice for the amount due when the goods are shipped. It is up to the buyer to honor that invoice and pay within an agreed upon period of time. Payment by the buyer is typically made via check or money transfer. Alternatively, payment can also be made via credit cards or similar credit arrangements.

The roles of the entities in such B2B transactions may vary. For example, while a particular business may operate in the role of a seller in a first transaction, in a different transaction that business may operate in the role of a buyer. Conversely, a business making a purchase in one transaction, may be in the role of selling goods or services in a subsequent transaction.

Therefore, there is a need for flexible systems and methods that allow currently available payment processing resources to be used to expedite and facilitate transactions between business entities.

### SUMMARY

Embodiments in accordance with the present invention relate to methods and systems allowing an electronic payment processing network to be utilized to conduct transactions between businesses (B2B), or between other entities. In one embodiment, funds may be transferred between businesses (a buyer, a seller) through a payment processing network utilizing offsetting credit and debit transactions to a dummy acquirer account. This payment may be achieved utilizing only conventional message types (request for authorization, settlement) that are expected to be transmitted over the network in the course of a familiar merchant/consumer purchase transaction. No special message type is required to be transmitted to inform the acquirer of the transaction.

Other embodiments of the invention are directed to systems and methods using, accessing, and/or providing the above-described functionality and services.

These and other embodiments of the invention are described in further detail below.

### BRIEF DESCRIPTION OF THE DRAWINGS

FIG. 1 shows a simplified schematic view of a conventional credit card transaction between a consumer and a merchant.

FIG. 2 shows a simplified schematic view of an example of a business-to-business transaction using a payment processing network.

FIG. 3 shows a simplified schematic view of an embodiment of a business-to-business transaction according to the present invention using a payment processing network.

FIGS. 3A-D show a simplified schematic views of different steps in a process for performing a business-to-business transaction according to the embodiment of FIG. 3.

FIG. 4 is a schematic illustration of a computer system for use in accordance with embodiments of the present invention.

FIG. 4A is an illustration of basic subsystems the computer system of FIG. 4.

FIG. 5 shows the steps of a simplified process flow of an embodiment in accordance with the present invention.

### DETAILED DESCRIPTION

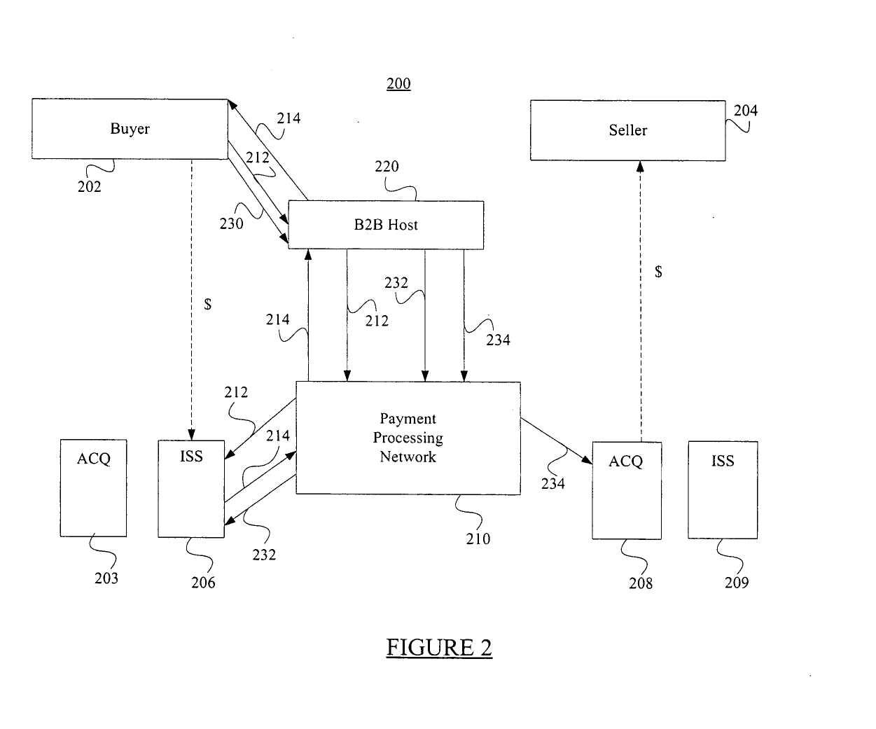

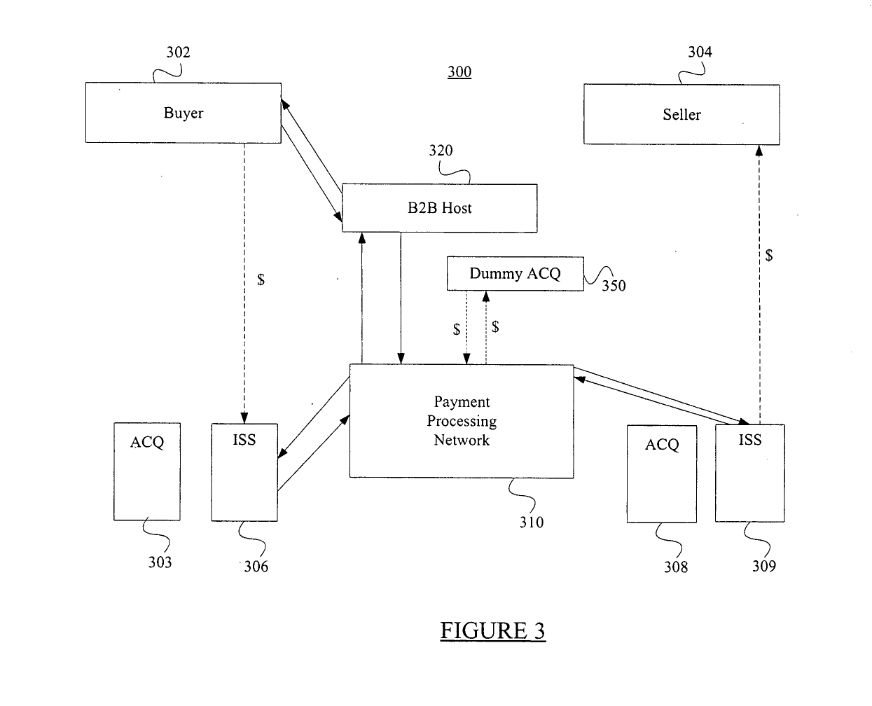

FIG. 2 shows a simplified view of the process flow 200 of transactions in a particular business-to-business (B2B) setting. Specifically, a first business entity 202 is configured to participate in an instant purchase transaction as a buyer, and hence is affiliated with an issuer 206. However, first business entity 202 is also configured to participate in other business transactions as a seller, and hence is also affiliated with an acquirer 203.

Second business entity 204 is configured to participate in the instant transaction as a seller, and hence is affiliated with an acquirer 208. In other business transactions, however, second business entity 204 is configured to participate as a buyer. Thus second business entity 204 is also affiliated with an issuer 209.

The issuers 206, 209, and acquirers 203, 208 are in electronic communication with each other through payment processing network 210. Payment processing network 210 is also in electronic communication with a host processing engine 220. The role of host processing engine 220 in conducting a B2B transaction is discussed in detail below, and is further described in connection with U.S. Nonprovisional patent application No. 10/020,466, filed Oct. 29, 2001, which is incorporated by reference herein for all purposes.

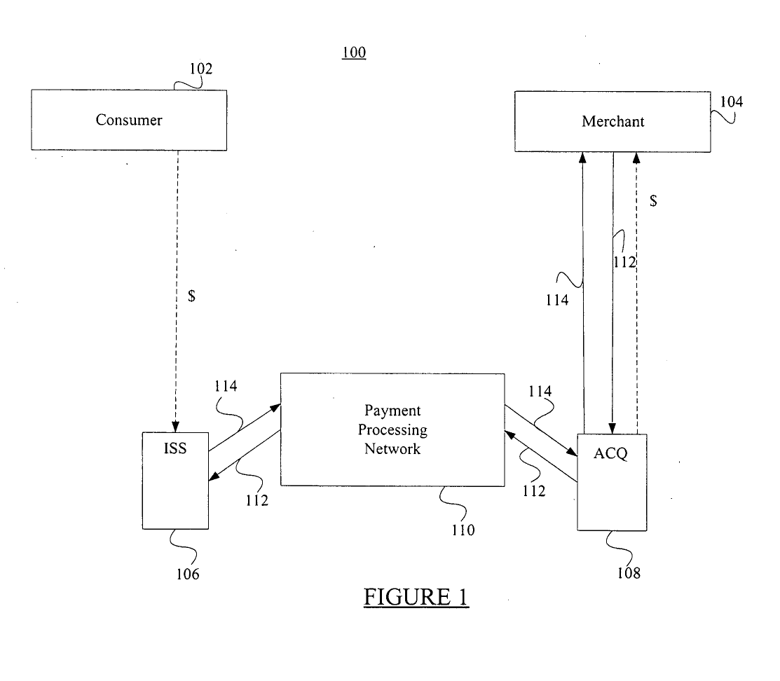

As mentioned above, in a business-to-business transaction environment, it is the buyer 202 who decides when to initiate payment in response to an invoice issued by the seller 204. Therefore, unlike the familiar consumer/merchant transaction flow shown in FIG. 1, the B2B transaction flow shown in FIG. 2 is initiated by the buyer 202.

Specifically, in a first step the buyer contacts the host processing engine 220 with a request for authorization message 212 to conduct a payment to seller 204. Both buyer 202 and seller 204 have previously recorded certain information with host processing engine 220, for example the identities of their issuers and acquirers, as well as the account information relevant to those issuers and acquirers.

Accordingly, host processing engine 220 is configured to route the request for authorization message 212 through the payment processing network 210 to the issuer 206 of the buyer 202. Issuer 206 is configured to check the amount of credit available in the buyer's account. If sufficient credit is available, issuer 206 is configured to return an authorization message 214 to the buyer though the payment processing network 210 and host processing engine 220.

If, upon receipt of the return authorization message 214, buyer 202 still wishes to process the payment, in the next step a settlement message 230 is transmitted to the host processing engine 220. Host processing engine 220 is configured to receive and recognize the settlement message 230, and in response, generate and send two separate messages through the electronic payment processing network 210.

In particular, settlement message 232 is sent to issuer 206, instructing the transfer of monies to the acquirer 208 of the seller 204. This message has the form of the conventional settlement message sent in the familiar consumer/merchant process flow shown and described above in connection with FIG. 1.

Host processing engine 220 is also configured to send a second message 234 over the payment processing network 210. Specifically, because the buyer has initiated the payment transaction, the acquirer 208 of the seller 204 is not aware that a payment is being made. Accordingly, the second message 234 is sent by the host processor to the acquirer 208 of the seller 204, alerting it to the existence of, and the particulars of, the payment transaction.

In particular, second message 234 includes a raw data file containing key information regarding the payment transaction that is expected to be received by the acquirer 208 of the seller 204. The raw data file of second message 234 includes such information as the date of the payment, the amount of the payment, the credit card account number of the entity making the payment, and the bank account or card account into which the transferred funds are to be deposited.

Upon receipt of this raw data file by acquirer 208, the B2B transaction can be completed by transmittal of the settlement message 232 from the buyer's issuer 206 to the seller's acquirer 208, which results in the transfer of funds from issuer 206 to acquirer 208. At a subsequent time, and not necessarily utilizing the electronic payment processing network, funds will be transferred to issuer 206 from buyer 202, and from acquirer 208 to seller 204.

While functional, the B2B transaction processing system shown in FIG. 2 may offer certain complexities. For example, the raw data files transmitted to the seller's acquirer are not a part of the familiar consumer/merchant transaction process flow. Accordingly, the acquirer must be willing to implement changes into its infrastructure allowing it to recognize and process the messages including raw data files. Making such changes can be costly to the acquirer, particularly where an initial expected volume of B2B transactions may be small.

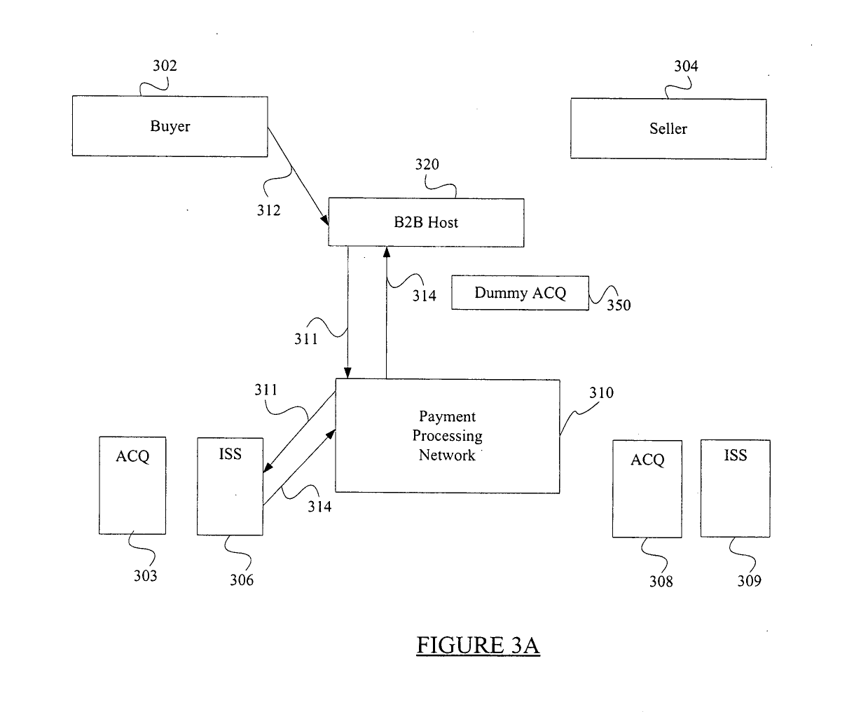

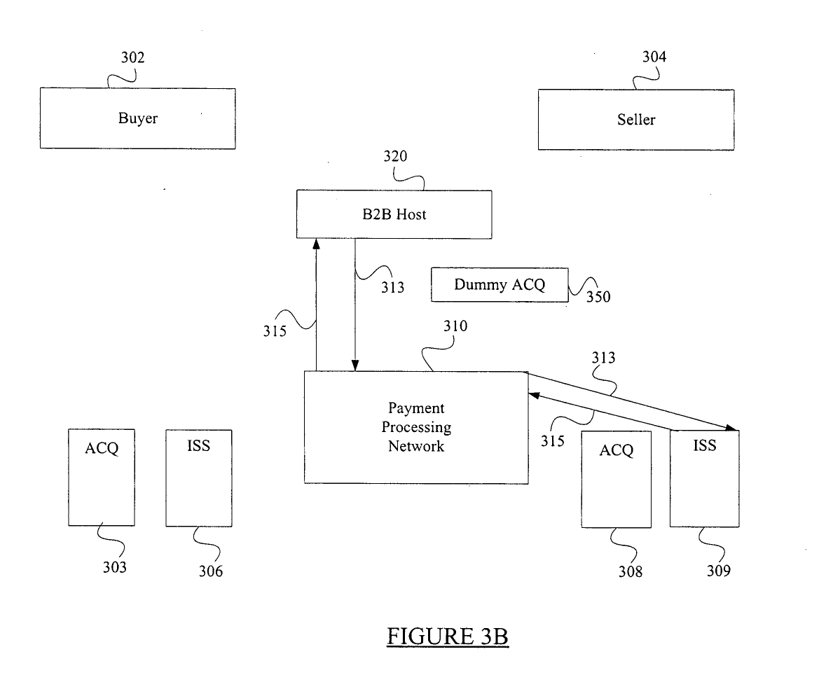

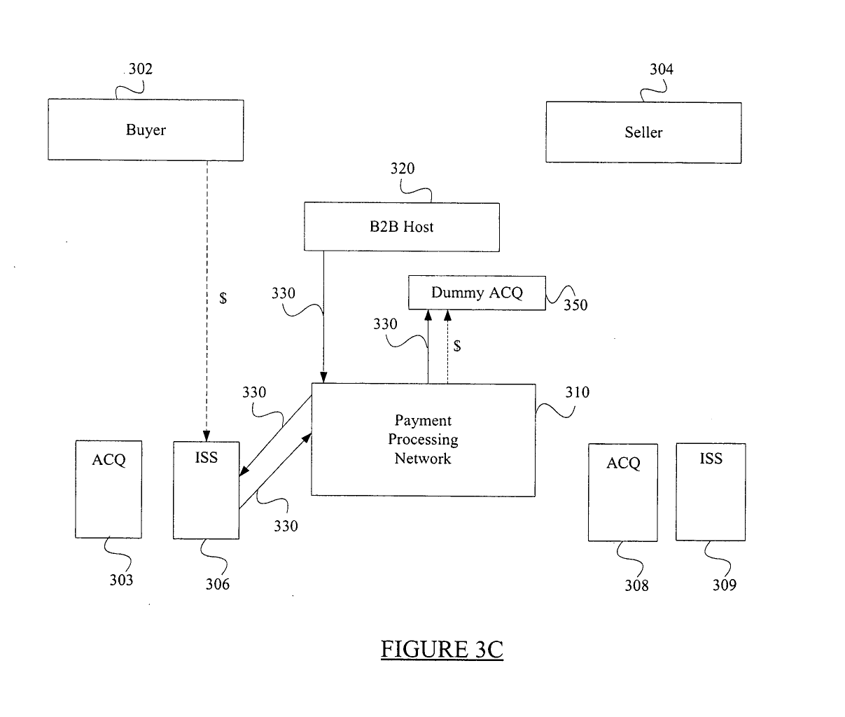

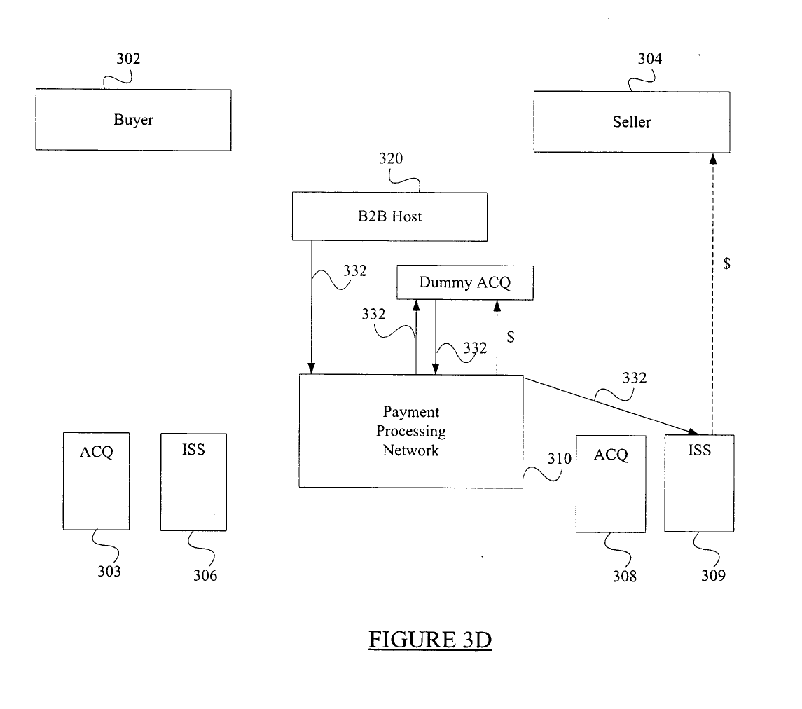

Accordingly, FIG. 3 shows a simplified schematic view of a system 300 utilizing an embodiment of a process flow in accordance with the present invention. The system 300 of FIG. 3 resembles that of FIG. 2, except that funds are transferred from the issuer 306 of the buyer 302, to the issuer 309 of the seller 304. This is accomplished by breaking up the flow into two separate transactions rather than one. In a first transaction, the funds are transferred as a credit from an account with the buyer's issuer 306, to an account with a dummy acquirer entity 350, that has been set up in advance. In a second transaction, the funds are transferred as a debit from the dummy acquirer 350 to the seller's issuer 309.

While requiring two separate transactions, the approach according to embodiments of the present invention utilizes only existing message types that are normally expected to be transmitted and received over a conventional payment processing network, thereby avoiding the need to specially notify the seller's acquirer. The specific flow of transaction processes according to an embodiment of the present invention is described in detail below in connection with FIGS. 3A-D.

FIG. 3A shows a first step in the process flow, wherein buyer 302 notifies host processing engine 320 that it wishes to make a payment to seller 304. Accordingly, buyer 302 transmits authorization request message 312 to host purchasing engine 320.

Host processing engine 320 receives authorization request message 312 from the buyer 302. In response, host processing engine 320 is configured to transmit authorization requests for two separate transactions. As shown in FIG. 3A, the first authorization request 311 is to the issuer 306 of buyer 302, to determine whether sufficient available credit exists in the buyer's account to cover the payment. Authorization of the proposed transaction results in an approval message 314 being transmitted back from issuer 306 to host processing engine 320 over payment processing network 310 in the conventional fashion.

As shown in FIG. 3B, host processing engine 320 is also configured to transmit a second authorization request message 313 to the issuer 309 of the seller, 304 to determine whether the seller's account is available to receive an electronic payment. Authorization of such a proposed deposit transaction results in a second approval message 315 being transmitted back from the seller's issuer 309 to host processing engine 320 over payment processing network 310 in the conventional fashion.

As shown in FIG. 3C, upon receipt of the second returned approval messages, host processing engine 320 proceeds to perform several tasks. As described above, the host processing engine 320 has previously established a dummy acquirer 350 having an account configured to receive funds from issuer 306 of the buyer 302. As shown in FIG. 3C, host processing engine 320 sends a first settlement message 330 debiting the buyer's account with issuer 306 for the amount of the transaction, and crediting the funds to an account of the dummy acquirer 330.

As shown in FIG. 3D, host processing engine 320 then sends a second settlement message 332 debiting the dummy acquirer 350 for the amount of the transaction, and crediting an account with the seller's issuer 309 for the amount of the payment.

Thus, utilizing offsetting credit and debit transactions to a dummy acquirer entity, funds may be transferred between businesses (buyer, seller) through a payment processing network, utilizing only conventional message types (request for authorization, settlement) expected to be transmitted over that network. No special message types (i.e. raw data files) are needed.

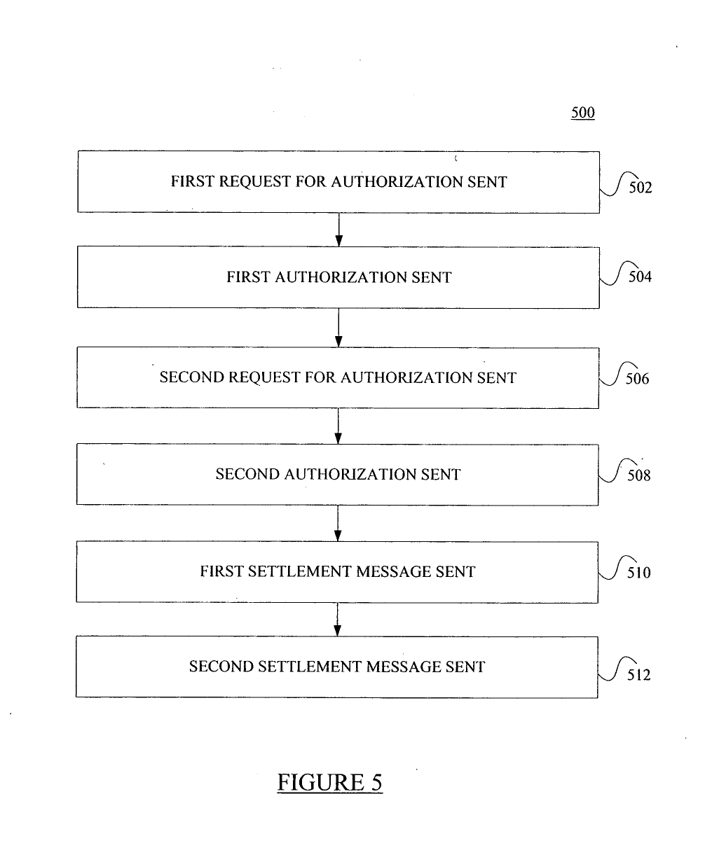

FIG. 5 shows the steps of a simplified process flow of an embodiment in accordance with the present invention. As shown in process flow 500, in a first step 502 a first request for authorization is sent through the payment processing network to the issuer of the payor. In a second step 504, a first authorization message is sent through the payment processing network from the issuer of the payor. In a third step 506, a second request for authorization is sent through the payment processing network to the issuer of the payee. In a fourth step 508, a second authorization message is sent through the payment processing network from the issuer of the payee. In a fifth step 510, a settlement message is sent through the payment processing network to the issuer of the payor, instructing the transfer of funds to the dummy acquirer. In a sixth step 512, a second settlement message is sent through the payment processing network to the issuer of the payee, instructing the transfer of funds from the dummy acquirer. Because the amount of funds transferred from the dummy acquirer exactly equals the amount of funds transferred into the dummy acquirer, in net settlement no actual funds will need to be transferred and the dummy acquirer will balance out

The system illustrated above represents only one example of an embodiment according to the present invention. Other variations are possible in accordance with alternative embodiments.

For instance, in the example described above, money is only deposited into the account established by the seller's acquirer to receive the electronic payments. By making this account credit only, the risk of fraud is reduced as monies cannot be transferred out of the account.

In accordance with alternative embodiments, however, the issuers of the seller set up the account type as credit or debit, depending on the services they want to offer their customers.

And while the embodiment just described is characterized in terms of a business-to-business (B2B) transaction, this is also not required by the present invention. In accordance with alternative embodiments, payments could be made electronically between individuals (person-to-person, P2P) utilizing an existing electronic payment system.

To understand such an alternative embodiment, it is important to recognize that the 16-digit numbers assigned to identify individual credit card accounts are unique across all nations, financial institutions, and sponsoring entities (i.e. Visa, MasterCard, Discover, and American Express). Identifying the destination of an electronic payment utilizing these unique 16-digit credit card account numbers according to embodiments of the present invention, thus allows for the transfer of funds to a unique destination across different issuers, nations, and even card sponsors. Such flexibility would enhance the use of electronic networks to accomplish payments to individuals utilizing embodiments in accordance with the present invention.

Embodiments in accordance with the present invention offer a number of potential benefits. One advantage is speed. Specifically, rather than the laborious, time-consuming, and error-prone process of mailing a payment to a seller in response to an invoice, embodiments in accordance with the present invention offer the immediate approval of existing funds for payment, and an immediate debit of existing funds. Such speed allows for flexibility in crafting the terms of payment, allowing for example a 30 day credit option.

Another advantage offered by embodiments in accordance with the present invention is relatively simple bookkeeping. Specifically, because the sum of the credit and debit transactions to the account of the dummy acquirer entity is necessarily zero, errors or even fraud are easily detectable.

Still another advantage offered by embodiments according to the present invention is the use of existing issuer systems to accomplish the transfer of funds. Specifically, a business will generally already have an existing relationship with the issuer of their corporate and/or purchasing credit cards for use by employees. Embodiments in accordance with the present invention leverage this existing relationship to allow the same issuer to receive electronic payments from buyers.

Moreover, such existing issuers are required to make little or no change to their infrastructures in order to accommodate payments made according to embodiments of the present invention. Specifically, the issuers are already configured to receive credit transactions for refunds and other charge-backs, so no special provisions are required to be made in order to receive the electronic funds transfer from the buyers.

Embodiments of the present invention also allow for easy reporting of the transactions to different parties. Specifically, the existing statements would show all debits, deposits, and charges for reconciliation purposes. Existing electronic files can be sent to a Management Information System (MIS) reporting services, which provide users with full reporting on payables and receivables. In addition, if the seller's issuer updates the MIS service on a regular basis, the seller will receive early notification of payment, allowing in more accurate management of cash flows.

Furthermore, reporting features of existing issuer accounts (i.e. monthly statements etc.) provide the ability to easily identify, itemize, and track different fees and charges, so that customized services related to the electronic processing can readily be charged to card holders. For example, the administrator of the electronic processing network typically passes a fee (known as interchange) between the Acquirer and the Issuer for each transaction. Because embodiments of the present invention require two transactions per payment, these interchange fees could increase the cost of making payments. According to certain embodiments, however, the accounts could be set up for zero interchange, with the banks or other financial institutions instead charging the customer for the electronic payment service.

Embodiments in accordance with the present invention are also readily marketable to potential business customers. Specifically, the embodiments offer a solution to both the accounts receivable and accounts payable arms of a business' accounting department, thereby enhancing the likelihood of adoption of this approach to electronic payment.

Another possible advantage offered by embodiments in accordance with the present invention includes the immediate notification of a seller bank of pending payments. To expedite such electronic processing of payments, the seller could include the specific number of the account with their issuer on invoices sent. In embodiments where the destination account is designated to receive funds only, this account number could be included without fear of subsequent fraudulent withdrawals.

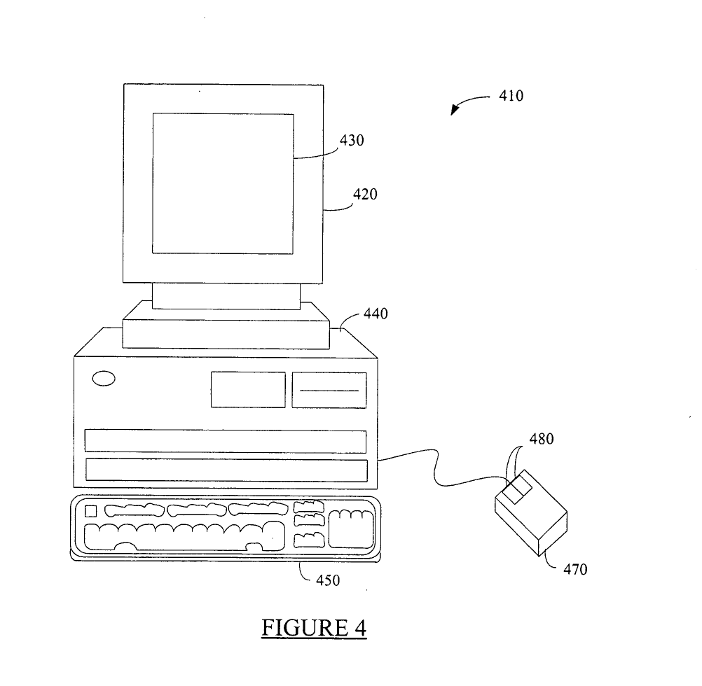

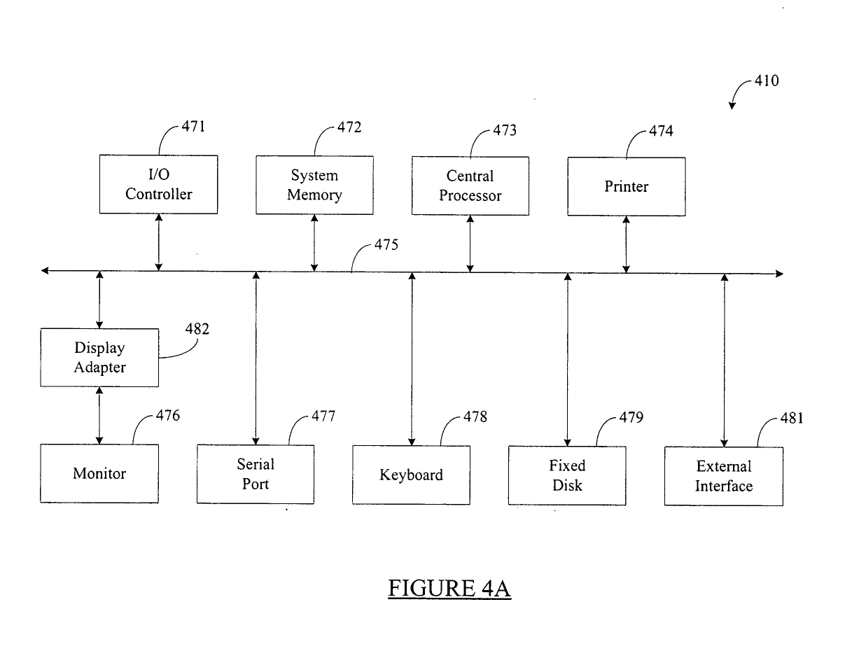

A computer system configured to perform the function of the host processing engine according to embodiments of the present invention is represented generically in the drawing of FIG. 4. Specifically, FIG. 4 shows computer system 410 including display device 420, display screen 430, cabinet 440, keyboard 450, and mouse 470.

Mouse 470 and keyboard 450 are representative “user input devices.” Mouse 470 includes buttons 480 for selection of buttons on a graphical user interface device. Other examples of user input devices are a touch screen, light pen, track ball, data glove, microphone, and so forth.

FIG. 4 is representative of but one type of system for embodying the present invention. It will be readily apparent to one of ordinary skill in the art that many system types and configurations are suitable for use in conjunction with the present invention. In one embodiment, computer system 410 includes a Pentium class based computer, running Windows NT operating system by Microsoft Corporation. However, the apparatus is easily adapted to other operating systems and architectures by those of ordinary skill in the art without departing from the scope of the present invention.

As noted, mouse 470 can have one or more buttons such as buttons 480. Cabinet 440 houses familiar computer components such as disk drives, a processor, storage device, etc. Storage devices include, but are not limited to, disk drives, magnetic tape, solid state memory, bubble memory, etc. Cabinet 440 can include additional hardware such as input/output (I/O) interface cards for connecting computer system 410 to external devices external storage, other computers or additional peripherals, further described below.

FIG. 4A is an illustration of basic subsystems in computer system 410 of FIG. 4. This diagram is merely an illustration and should not limit the scope of the claims herein. One of ordinary skill in the art will recognize other variations, modifications, and alternatives. In certain embodiments, the subsystems are interconnected via a system bus 475. Additional subsystems such as a printer 474, keyboard 478, fixed disk 479, monitor 476, which is coupled to display adapter 482, and others are shown. Peripherals and input/output (I/O) devices, which couple to I/O controller 471, can be connected to the computer system by any number of means known in the art, such as serial port 477. For example, serial port 477 can be used to connect the computer system to a modem 481, which in turn connects to a wide area network such as the Internet, a mouse input device, or a scanner. The interconnection via system bus allows central processor 473 to communicate with each subsystem and to control the execution of instructions from system memory 472 or the fixed disk 479, as well as the exchange of information between subsystems. Other arrangements of subsystems and interconnections are readily achievable by those of ordinary skill in the art. System memory, and the fixed disk are examples of tangible media for storage of computer programs, other types of tangible media include floppy disks, removable hard disks, optical storage media such as CD-ROMS and bar codes, and semiconductor memories such as flash memory, read-only-memories (ROM), and battery backed memory.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of making a payment over an electronic payment processing network, the method comprising:
transferring an amount of funds from an issuer of a payor to an account of a dummy acquirer entity; and
transferring the amount of funds from the account to an issuer of a payee.

2. The method of claim 1 wherein the payor comprises a first business that has purchased goods or services from a second business comprising the payee.

3. The method of claim 1 wherein the payor comprises an individual and the payee comprises a second individual.

4. The method of claim 1 wherein the amount of funds is transferred to the account by,
sending a first request for authorization through the payment processing network to the issuer of the payor,
receiving a first authorization message through the payment processing network from the issuer of the payor,
in response to receipt of the first authorization message, sending a second request for authorization through the payment processing network to the issuer of the payee,
receiving a second authorization message through the payment processing network from the issuer of the payee, and
sending a settlement message through the payment processing network to the issuer of the payor.

5. The method of claim 4 wherein the first request for authorization is sent by a host processing engine in response to a request from the payor.

6. The method of claim 5 wherein the settlement message is automatically generated by the host processing engine in response to receipt of the second authorization message.

7. The method of claim 4 wherein the first request for authorization and the second request for authorization include a 16 digit number uniquely identifying an account of the payor.

8. The method of claim 1 wherein the amount of funds is transferred from the account by sending a settlement message through the payment processing network to the issuer of the payee.

9. The method of claim 8 wherein the request for authorization is automatically generated and sent by a host processing engine in response to receipt of earlier authorization messages received from the issuer of the payor and the issuer of the payee.

10. A host processing engine for use in conjunction with an electronic payment processing network, the host processing engine comprising:
a processor; and
a computer readable storage medium in electronic communication with the processor and having stored thereon code instructing the processor to,
receive from a payor, a request to transfer of an amount of funds from a payor to a payee utilizing an electronic payment network,
in response to receiving the request, send instructions to transfer the amount of funds from an issuer of a payor to an account of a dummy acquirer entity, and
send instructions to transfer the amount of funds from the account of the dummy acquirer entity to an issuer of a payee.

11. The host processing engine of claim 10 wherein the computer readable storage medium includes code stored thereon directing the processor to,
send a first request for authorization through the payment processing network to the issuer of the payor,
receiving a first authorization message through the payment processing network from the issuer of the payor,
in response to receipt of the first authorization message, send a second request for authorization through the payment processing network to the issuer of the payee,
receive a second authorization message through the payment processing network from the issuer of the payee,
in response to receipt of the second authorization message, send a settlement message through the payment processing network instructing transfer of the funds to the account of the dummy acquirer entity; and
send a settlement message through the payment processing network to account of the dummy acquirer, instructing transfer of the funds to the issuer of the payee.

12. The host processing engine of claim 10 wherein the computer readable storage medium is configured to include in the first request for authorization or the second request for authorization, a 16 digit number uniquely identifying an account of the payor.

13. The host processing engine of claim 10 wherein the computer readable storage medium further includes code stored thereon to establish the account of the dummy acquirer entity, in response to receipt of the request for the transfer of funds.

14. A method of transferring funds over an electronic payment processing network, the method comprising:
conducting a first transaction over the electronic payment processing network debiting an amount from an issuer of a payor and crediting the amount to an account of a dummy acquirer entity; and then
conducting a second transaction over the electronic payment processing network crediting the amount to an issuer of the payee and debiting the amount from the account of the dummy acquirer entity, wherein the first and second transaction are conducted utilizing only messages of a type employed in the course of a merchant/customer payment.

15. The method of claim 14 wherein the payor comprises a first business that has purchased goods or services from a second business comprising the payee.

16. The method of claim 14 wherein the payor comprises an individual and the payee comprises a second individual.

17. The method of claim 14 wherein the first transaction is conducted by,
sending a first request for authorization through the payment processing network to the issuer of the payor,
receiving a first authorization message through the payment processing network from the issuer of the payor,
in response to receipt of the first authorization message, sending a second request for authorization through the payment processing network to the issuer of the payee,
receiving a second authorization message through the payment processing network from the issuer of the payee, and
sending a settlement message through the payment processing network to the issuer of the payor.

18. The method of claim 17 wherein the second transaction is conducted by sending a second settlement message through the payment processing network to the issuer of the payee.

19. The method of claim 17 wherein the first request for authorization is sent by a host processing engine in response to a request from the payor.

20. The method of claim 17 wherein the first request for authorization and the second request for authorization include a 16 digit number uniquely identifying an account of the payor.
